(19) United States
(12) Patent Application Publication
(10) Pub. No.: US 2025/0330569 A1
(43) Pub. Date: Oct. 23, 2025

(54) CROSS-COMPONENT PREDICTION FOR CHROMA PREDICTION

(71) Applicant: Alibaba (China) Co., Ltd., Hangzhou (CN)

(72) Inventors: Xinwei Li, Beijing (CN); Ru-ling Liao, Sunnyvale, CA (US); Jie Chen, Beijing (CN); Yan Ye, San Diego, CA (US)

(21) Appl. No.: 19/007,419

(22) Filed: Dec. 31, 2024

Related U.S. Application Data
(60) Provisional application No. 63/618,380, filed on Jan. 7, 2024.

(51) Int. Cl. H04N 19/105; H04N 19/176; H04N 19/186

(52) U.S. Cl. CPC H04N 19/105; H04N 19/176; H04N 19/186

(57) ABSTRACT

Methods and systems implement cross-component prediction (“CCP”) for chroma prediction, to improve prediction accuracy. A VVC-standard encoder and a VVC-standard decoder can configure one or more processors of a computing system to perform chroma fusion inheritance in CCP merge modes; update a CCP model by a current reconstructed block; perform adaptive fusion for interCCCM mode and inter-CCP merge mode; and perform adaptive model derivation for interCCCM mode.

### RELATED APPLICATIONS

The present U.S. Non-provisional Patent application claims the priority benefit of a first prior-filed U.S. Provisional Patent Application having the title “IMPROVEMENTS TO CROSS-COMPONENT PREDICTION FOR MOTION PREDICTION,” Ser. No. 63/618,380 filed Jan. 7, 2024, The entire contents of the identified earlier-filed U.S. Provisional Patent Applications are hereby incorporated by reference into the present patent application.

### BACKGROUND

In 2020, the Joint Video Experts Team (“JVET”) of the ITU-T Video Coding Expert Group (“ITU-T VCEG”) and the ISO/IEC Moving Picture Expert Group (“ISO/IEC MPEG”) published the final draft of the next-generation video codec specification, Versatile Video Coding (“VVC”). This specification further improves video coding performance over prior standards such as H.264/AVC (Advanced Video Coding) and H.265/HEVC (High Efficiency Video Coding). The JVET continues to propose additional techniques beyond the scope of the VVC standard itself, collected under the Enhanced Compression Model (“ECM”) name.

According to the VVC standard, an encoder and a decoder partition picture data into blocks, and perform motion prediction upon luma and chroma components of the blocks. Cross-component prediction (“CCP”) is further implemented, providing a linear model interrelating collocated luma and chroma samples, by which a chroma sample can be predicted from a collocated luma sample.

Moreover, at time of writing, the latest draft of ECM (presented at the 36th meeting of the JVET in November 2024 as “Algorithm description of Enhanced Compression Model 15 (ECM 15)”) includes proposals to further implement cross-component prediction. Blocks can be further subdivided, and different linear models applied to predict different subdivisions. A linear model can be derived from individual samples or from sample gradients. Cross-component prediction output can be fused with other prediction output, and cross-component prediction can be further applied to merge mode in intra prediction and inter prediction.

There is a need to further improve the capabilities of cross-component prediction over the functionality provided by the VVC standard and by ECM.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIGS. 1A and 1B illustrate example block diagrams of, respectively, an encoding process and a decoding process according to an example embodiment of the present disclosure.

FIGS. 2A, 2B, and 2C illustrate implementation of a Cross Component Linear Model (“CCLM”) mode according to the VVC standard.

FIGS. 3A, 3B, and 3C illustrate adjacent samples referenced in various CCLM modes.

FIGS. 4A and 4B illustrate slope adjustment of a CCLM model.

FIG. 5 illustrates a convolutional 7-tap filter implemented by a Convolutional Cross-Component Model (“CCCM”) mode.

FIG. 6 illustrates a reference area which includes 2 or 6 lines of chroma samples above and left of the PU according to CCCM mode.

FIG. 7 illustrates four non-down-sampled luma samples of CCCM mode (“NS-CCCM”).

FIG. 8A and FIG. 8B illustrate a reference area in the luma and chroma channels, respectively, according to a block-vector guided CCM (“BVG-CCCM”) mode.

FIG. 9 illustrates spatial samples referenced in a gradient and location-based CCCM model (“GL-CCCM”) mode.

FIGS. 10A through 10D illustrate down-sampling filters and a current chroma sample position according to CCCM mode with multiple down-sampling filters (“MDF-CCCM”).

FIGS. 11A through 11D illustrate Sobel-based gradient patterns according to a Gradient Linear Model (“GLM”).

FIG. 12 illustrates a 3×3 low-pass filter applied to filter prediction samples generated by multi-mode CCLM (“MM-CCLM”) or multi-mode CCCM (“MM-CCCM”).

FIG. 13 illustrates a CCCM inter-prediction (“interCCCM”) model as implemented by a VVC-standard decoder.

FIG. 14 illustrates six luma samples closest to a chroma position C without down-sampling in an application of interCCCM.

FIGS. 15A and 15B illustrate samples by which an adjacent-reconstructed CCP model and a self-reconstructed CCP model are derived according to example embodiments of the present disclosure.

FIGS. 16A through 16E illustrate predicted luma and chroma samples in different parts of the current block used to derive the interCCCM model according to example embodiments of the present disclosure.

FIG. 17 illustrates an example system for implementing the processes and methods described herein for implementing cross-component prediction.

### DETAILED DESCRIPTION

Systems and methods discussed herein are directed to implementing cross-component prediction (“CCP”) for chroma prediction, and more specifically chroma fusion inheritance in CCP merge modes; updating a CCP model by a current reconstructed block; adaptive fusion for interCCCM mode and inter-CCP merge mode; and adaptive model derivation for interCCCM mode.

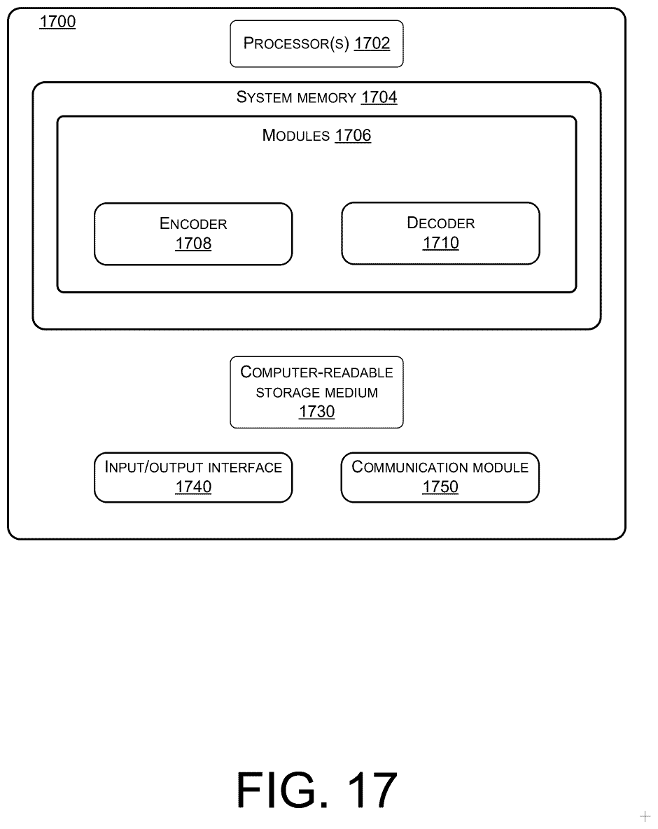

In accordance with the VVC video coding standard (the “VVC standard”) and motion prediction as described therein, a computing system includes at least one or more processors and a computer-readable storage medium communicatively coupled to the one or more processors. The computer-readable storage medium is a non-transient or non-transitory computer-readable storage medium, as defined subsequently with reference to FIG. 17, storing computer-readable instructions. At least some computer-readable instructions stored on a computer-readable storage medium are executable by one or more processors of a computing system to configure the one or more processors to perform associated operations of the computer-readable instructions, including at least operations of an encoder as described by the VVC standard, and operations of a decoder as described by the VVC standard. Some of these encoder operations and decoder operations according to the VVC standard are subsequently described in further detail, though these subsequent descriptions should not be understood as exhaustive of encoder operations and decoder operations according to the VVC standard. Subsequently, a “VVC-standard encoder” and a “VVC-standard decoder” shall describe the respective computer-readable instructions stored on a computer-readable storage medium which configure one or more processors to perform these respective operations (which can be called, by way of example, “reference implementations” of an encoder or a decoder).

Moreover, according to example embodiments of the present disclosure, a VVC-standard encoder and a VVC-standard decoder further include computer-readable instructions stored on a computer-readable storage medium which are executable by one or more processors of a computing system to configure the one or more processors to perform operations not specified by the VVC standard. A VVC-standard encoder should not be understood as limited to operations of a reference implementation of an encoder, but including further computer-readable instructions configuring one or more processors of a computing system to perform further operations as described herein. A VVC-standard decoder should not be understood as limited to operations of a reference implementation of a decoder, but including further computer-readable instructions configuring one or more processors of a computing system to perform further operations as described herein.

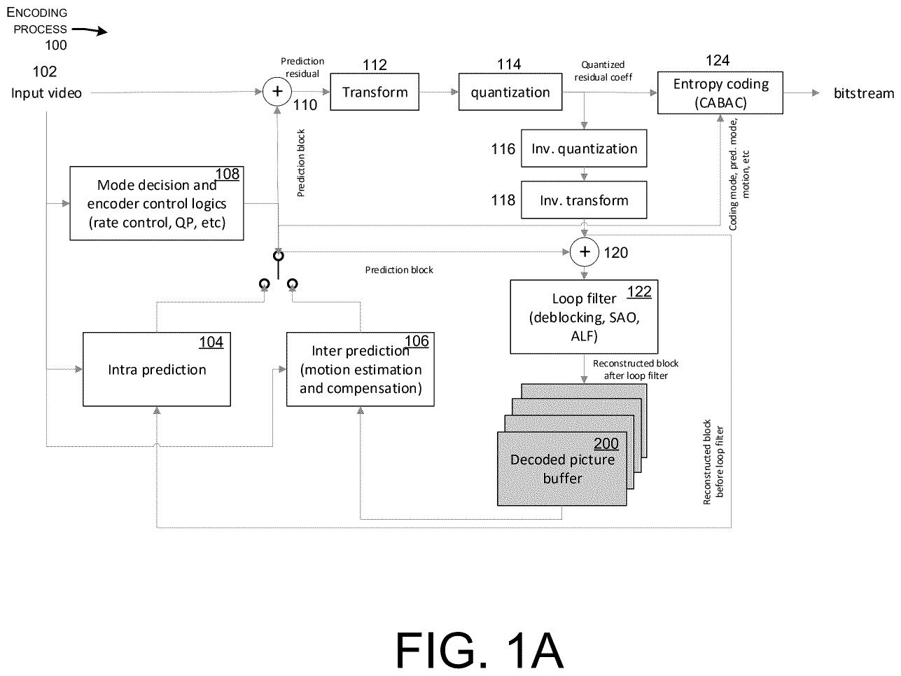

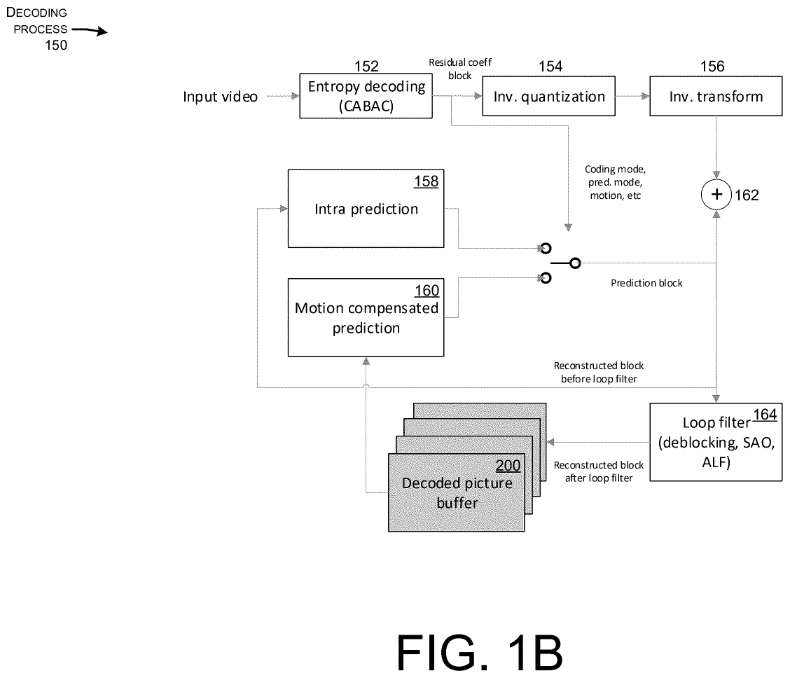

FIGS. 1A and 1B illustrate example block diagrams of, respectively, an encoding process 100 and a decoding process 150 according to an example embodiment of the present disclosure.

In an encoding process 100, a VVC-standard encoder configures one or more processors of a computing system to receive, as input, one or more input pictures from an image source 102. An input picture includes some number of pixels sampled by an image capture device, such as a photosensor array, and includes an uncompressed stream of multiple color channels (such as RGB color channels) storing color data at an original resolution of the picture, where each channel stores color data of each pixel of a picture using some number of bits. A VVC-standard encoder configures one or more processors of a computing system to store this uncompressed color data in a compressed format, wherein color data is stored at a lower resolution than the original resolution of the picture, encoded as a luma (“Y”) channel and two chroma (“U” and “V”) channels of lower resolution than the luma channel.

A VVC-standard encoder encodes a picture (a picture being encoded being called a “current picture,” as distinguished from any other picture received from an image source 102) by configuring one or more processors of a computing system to partition the original picture into units and subunits according to a partitioning structure. A VVC-standard encoder configures one or more processors of a computing system to subdivide a picture into macroblocks (“MBs”) each having dimensions of 16×16 pixels, which may be further subdivided into partitions. A VVC-standard encoder configures one or more processors of a computing system to subdivide a picture into coding tree units (“CTUs”), the luma and chroma components of which may be further subdivided into coding tree blocks (“CTBs”) which are further subdivided into coding units (“CUs”). Alternatively, a VVC-standard encoder configures one or more processors of a computing system subdivide a picture into units of N×N pixels, which may then be further subdivided into subunits. Each of these largest subdivided units of a picture may generally be referred to as a “block” for the purpose of this disclosure.

A CU is coded using one block of luma samples and two corresponding blocks of chroma samples, where pictures are not monochrome and are coded using one coding tree.

A VVC-standard encoder configures one or more processors of a computing system to subdivide a block into partitions having dimensions in multiples of 4×4 pixels. For example, a partition of a block may have dimensions of 8×4 pixels, 4×8 pixels, 8×8 pixels, 16×8 pixels, or 8×16 pixels.

By encoding color information of blocks of a picture and subdivisions thereof, rather than color information of pixels of a full-resolution original picture, a VVC-standard encoder configures one or more processors of a computing system to encode color information of a picture at a lower resolution than the input picture, storing the color information in fewer bits than the input picture.

Furthermore, a VVC-standard encoder encodes a picture by configuring one or more processors of a computing system to perform motion prediction upon blocks of a current picture. Motion prediction coding refers to storing image data of a block of a current picture (where the block of the original picture, before coding, is referred to as an “input block”) using motion information and prediction units (“PUs”), rather than pixel data, according to intra prediction 104 or inter prediction 106.

Motion information refers to data describing motion of a block structure of a picture or a unit or subunit thereof, such as motion vectors and references to blocks of a current picture or of a reference picture. PUs may refer to a unit or multiple subunits corresponding to a block structure among multiple block structures of a picture, such as an MB or a CTU, wherein blocks are partitioned based on the picture data and are coded according to the VVC standard. Motion information corresponding to a PU may describe motion prediction as encoded by a VVC-standard encoder as described herein.

A VVC-standard encoder configures one or more processors of a computing system to code motion prediction information over each block of a picture in a coding order among blocks, such as a raster scanning order wherein a first-decoded block is an uppermost and leftmost block of the picture. A block being encoded is called a “current block,” as distinguished from any other block of a same picture.

According to intra prediction 104, one or more processors of a computing system are configured to encode a block by references to motion information and PUs of one or more other blocks of the same picture. According to intra prediction coding, one or more processors of a computing system perform an intra prediction 104 (also called spatial prediction) computation by coding motion information of the current block based on spatially neighboring samples from spatially neighboring blocks of the current block.

According to inter prediction 106, one or more processors of a computing system are configured to encode a block by references to motion information and PUs of one or more other pictures. One or more processors of a computing system are configured to store one or more previously coded and decoded pictures in a reference picture buffer for the purpose of inter prediction coding; these stored pictures are called reference pictures.

One or more processors are configured to perform an inter prediction 106 (also called temporal prediction or motion compensated prediction) computation by coding motion information of the current block based on samples from one or more reference pictures. Inter prediction may further be computed according to uni-prediction or bi-prediction: in uni-prediction, only one motion vector, pointing to one reference picture, is used to generate a prediction signal for the current block. In bi-prediction, two motion vectors, each pointing to a respective reference picture, are used to generate a prediction signal of the current block.

A VVC-standard encoder configures one or more processors of a computing system to code a CU to include reference indices to identify, for reference of a VVC-standard decoder, the prediction signal(s) of the current block. One or more processors of a computing system can code a CU to include an inter prediction indicator. An inter prediction indicator indicates list 0 prediction in reference to a first reference picture list referred to as list 0, list 1 prediction in reference to a second reference picture list referred to as list 1, or bi-prediction in reference to both reference picture lists referred to as, respectively, list 0 and list 1.

In the cases of the inter prediction indicator indicating list 0 prediction or list 1 prediction, one or more processors of a computing system are configured to code a CU including a reference index referring to a reference picture of the reference picture buffer referenced by list 0 or by list 1, respectively. In the case of the inter prediction indicator indicating bi-prediction, one or more processors of a computing system are configured to code a CU including a first reference index referring to a first reference picture of the reference picture buffer referenced by list 0, and a second reference index referring to a second reference picture of the reference picture referenced by list 1.

A VVC-standard encoder configures one or more processors of a computing system to code each current block of a picture individually, outputting a prediction block for each. According to the VVC standard, a CTU can be as large as 128×128 luma samples (plus the corresponding chroma samples, depending on the chroma format). A CTU may be further partitioned into CUs according to a quad-tree, binary tree, or ternary tree. One or more processors of a computing system are configured to ultimately record coding parameter sets such as coding mode (intra mode or inter mode), motion information (reference index, motion vectors, etc.) for inter-coded blocks, and quantized residual coefficients, at syntax structures of leaf nodes of the partitioning structure.

After a prediction block is output, a VVC-standard encoder configures one or more processors of a computing system to send coding parameter sets such as coding mode (i.e., intra or inter prediction), a mode of intra prediction or a mode of inter prediction, and motion information to an entropy coder 124 (as described subsequently).

The VVC standard provides semantics for recording coding parameter sets for a CU. For example, with regard to the above-mentioned coding parameter sets, pred_mode flag for a CU is set to 0 for an inter-coded block, and is set to 1 for an intra-coded block; general merge flag for a CU is set to indicate whether merge mode is used in inter prediction of the CU; inter_affine_flag and cu_affine_type_flag for a CU are set to indicate whether affine motion compensation is used in inter prediction of the CU; mvp_l0_flag and mvp_l1_flag are set to indicate a motion vector index in list 0 or in list 1, respectively; and ref_idx_l0 and ref_idx_l1 are set to indicate a reference picture index in list 0 or in list 1, respectively. It should be understood that the VVC standard includes semantics for recording various other information, flags, and options which are beyond the scope of the present disclosure.

A VVC-standard encoder further implements one or more mode decision and encoder control settings 108, including rate control settings. One or more processors of a computing system are configured to perform mode decision by, after intra or inter prediction, selecting an optimized prediction mode for the current block, based on the rate-distortion optimization method.

A rate control setting configures one or more processors of a computing system to assign different quantization parameters (“QPs”) to different pictures. Magnitude of a QP determines a scale over which picture information is quantized during encoding by one or more processors (as shall be subsequently described), and thus determines an extent to which the encoding process 100 discards picture information (due to information falling between steps of the scale) from MBs of the sequence during coding.

A VVC-standard encoder further implements a subtractor 110. One or more processors of a computing system are configured to perform a subtraction operation by computing a difference between an input block and a prediction block. Based on the optimized prediction mode, the prediction block is subtracted from the input block. The difference between the input block and the prediction block is called prediction residual, or “residual” for brevity.

Based on a prediction residual, a VVC-standard encoder further implements a transform 112. One or more processors of a computing system are configured to perform a transform operation on the residual by a matrix arithmetic operation to compute an array of coefficients (which can be referred to as “residual coefficients,” “transform coefficients,” and the like), thereby encoding a current block as a transform block (“TB”). Transform coefficients may refer to coefficients representing one of several spatial transformations, such as a diagonal flip, a vertical flip, or a rotation, which may be applied to a sub-block.

It should be understood that a coefficient can be stored as two components, an absolute value and a sign, as shall be described in further detail subsequently.

Sub-blocks of CUs, such as PUs and TBs, can be arranged in any combination of sub-block dimensions as described above. A VVC-standard encoder configures one or more processors of a computing system to subdivide a CU into a residual quadtree (“RQT”), a hierarchical structure of TBs. The RQT provides an order for motion prediction and residual coding over sub-blocks of each level and recursively down each level of the RQT.

A VVC-standard encoder further implements a quantization 114. One or more processors of a computing system are configured to perform a quantization operation on the residual coefficients by a matrix arithmetic operation, based on a quantization matrix and the QP as assigned above. Residual coefficients falling within an interval are kept, and residual coefficients falling outside the interval step are discarded.

A VVC-standard encoder further implements an inverse quantization 116 and an inverse transform 118. One or more processors of a computing system are configured to perform an inverse quantization operation and an inverse transform operation on the quantized residual coefficients, by matrix arithmetic operations which are the inverse of the quantization operation and transform operation as described above. The inverse quantization operation and the inverse transform operation yield a reconstructed residual.

A VVC-standard encoder further implements an adder 120. One or more processors of a computing system are configured to perform an addition operation by adding a prediction block and a reconstructed residual, outputting a reconstructed block.

A VVC-standard encoder further implements a loop filter 122. One or more processors of a computing system are configured to apply a loop filter, such as a deblocking filter, a sample adaptive offset (“SAO”) filter, and adaptive loop filter (“ALF”) to a reconstructed block, outputting a filtered reconstructed block.

A VVC-standard encoder further configures one or more processors of a computing system to output a filtered reconstructed block to a decoded picture buffer (“DPB”) 200. A DPB 200 stores reconstructed pictures which are used by one or more processors of a computing system as reference pictures in coding pictures other than the current picture, as described above with reference to inter prediction.

A VVC-standard encoder further implements an entropy coder 124. One or more processors of a computing system are configured to perform entropy coding, wherein, according to the Context-Sensitive Binary Arithmetic Codec (“CABAC”), symbols making up quantized residual coefficients are coded by mappings to binary strings (subsequently “bins”), which can be transmitted in an output bitstream at a compressed bitrate. The symbols of the quantized residual coefficients which are coded include absolute values of the residual coefficients (these absolute values being subsequently referred to as “residual coefficient levels”).

Thus, the entropy coder configures one or more processors of a computing system to code residual coefficient levels of a block; bypass coding of residual coefficient signs and record the residual coefficient signs with the coded block; record coding parameter sets such as coding mode, a mode of intra prediction or a mode of inter prediction, and motion information coded in syntax structures of a coded block (such as a picture parameter set (“PPS”) found in a picture header, as well as a sequence parameter set (“SPS”) found in a sequence of multiple pictures); and output the coded block.

A VVC-standard encoder configures one or more processors of a computing system to output a coded picture, made up of coded blocks from the entropy coder 124. The coded picture is output to a transmission buffer, where it is ultimately packed into a bitstream for output from the VVC-standard encoder. The bitstream is written by one or more processors of a computing system to a non-transient or non-transitory computer-readable storage medium of the computing system, for transmission.

In a decoding process 150, a VVC-standard decoder configures one or more processors of a computing system to receive, as input, one or more coded pictures from a bitstream.

A VVC-standard decoder implements an entropy decoder 152. One or more processors of a computing system are configured to perform entropy decoding, wherein, according to CABAC, bins are decoded by reversing the mappings of symbols to bins, thereby recovering the entropy-coded quantized residual coefficients. The entropy decoder 152 outputs the quantized residual coefficients, outputs the coding-bypassed residual coefficient signs, and also outputs the syntax structures such as a PPS and a SPS.

A VVC-standard decoder further implements an inverse quantization 154 and an inverse transform 156. One or more processors of a computing system are configured to perform an inverse quantization operation and an inverse transform operation on the decoded quantized residual coefficients, by matrix arithmetic operations which are the inverse of the quantization operation and transform operation as described above. The inverse quantization operation and the inverse transform operation yield a reconstructed residual.

Furthermore, based on coding parameter sets recorded in syntax structures such as PPS and a SPS by the entropy coder 124 (or, alternatively, received by out-of-band transmission or coded into the decoder), and a coding mode included in the coding parameter sets, the VVC-standard decoder determines whether to apply intra prediction 156 (i.e., spatial prediction) or to apply motion compensated prediction 158 (i.e., temporal prediction) to the reconstructed residual.

In the event that the coding parameter sets specify intra prediction, the VVC-standard decoder configures one or more processors of a computing system to perform intra prediction 158 using prediction information specified in the coding parameter sets. The intra prediction 158 thereby generates a prediction signal.

In the event that the coding parameter sets specify inter prediction, the VVC-standard decoder configures one or more processors of a computing system to perform motion compensated prediction 160 using a reference picture from a DPB 200. The motion compensated prediction 160 thereby generates a prediction signal.

A VVC-standard decoder further implements an adder 162. The adder 162 configures one or more processors of a computing system to perform an addition operation on the reconstructed residuals and the prediction signal, thereby outputting a reconstructed block.

A VVC-standard decoder further implements a loop filter 164. One or more processors of a computing system are configured to apply a loop filter, such as a deblocking filter, a SAO filter, and ALF to a reconstructed block, outputting a filtered reconstructed block.

A VVC-standard decoder further configures one or more processors of a computing system to output a filtered reconstructed block to the DPB 200. As described above, a DPB 200 stores reconstructed pictures which are used by one or more processors of a computing system as reference pictures in coding pictures other than the current picture, as described above with reference to motion compensated prediction.

A VVC-standard decoder further configures one or more processors of a computing system to output reconstructed pictures from the DPB to a user-viewable display of a computing system, such as a television display, a personal computing monitor, a smartphone display, or a tablet display.

Therefore, as illustrated by an encoding process 100 and a decoding process 150 as described above, a VVC-standard encoder and a VVC-standard decoder each implements motion prediction coding in accordance with the VVC specification. A VVC-standard encoder and a VVC-standard decoder each configures one or more processors of a computing system to generate a reconstructed picture based on a previous reconstructed picture of a DPB according to motion compensated prediction as described by the VVC standard, wherein the previous reconstructed picture serves as a reference picture in motion compensated prediction as described herein.

According to the VVC standard, coding trees are configured to provide separate block tree structures for the luma and chroma components of a picture. A CTU can include three CTBs, these in turn including one luma CTB (“Y”) and two chroma CTBs (“Cb” and “Cr”).

For P slices and B slices, luma and chroma CTBs of one CTU are configured to share a common coding tree structure. However, for I slices, the luma and chroma CTBs can be configured having separate block tree structures. Given a coding tree configured for separate block trees, a luma CTB is partitioned into CUs by a first coding tree structure, and chroma CTBs are partitioned into chroma CUs by a second coding tree structure.

In other words, while a CU of an I slice may contain a coding block of the luma component or coding blocks of two chroma components, a CU in a P or B slice contains coding blocks of all three color components (unless the video is monochrome).

According to the VVC standard, a relationship between the luma component and the chroma components is represented by a Cross Component Linear Model (“CCLM”). Equation 1 below predicts a chroma sample of a block from a collocated reconstructed luma sample by a linear model:

$${pred}_{C} ( i , j ) = α \cdot {rec}_{L}^{′} ( i , j ) + β$$

where pred_{C}(i,j) represents the predicted values of the chroma samples in the current block and rec_{L}′(i,j) represents the reconstructed values of the collocated luma samples of the same block which are down-sampled for the case of non-4:4:4 color format; and (i,j) is the coordinate of a sample in the block. The linear model is composed of the parameters a and B, whose values are derived based on reconstructed samples that are adjacent to the current block at both encoder and decoder side without explicit signaling.

Three CCLM modes, CCLM_LT, CCLM_L and CCLM_T, are specified in the VVC standard. These three modes differ with respect to the locations of the reconstructed adjacent samples that are used for linear model parameters (α and β) derivation. The above reconstructed adjacent samples are involved in the CCLM_T mode and the left reconstructed adjacent samples are involved in the CCLM_L mode. In the CCLM_LT mode, both above and left reconstructed adjacent samples are used.

In the signaling of the chroma intra mode, a flag indicating whether CCLM is applied is signaled first. If the flag is signaled as true, it is further signaled which of the three CCLM modes is applied.

To match the chroma sample locations for 4:2:0 or 4:2:2 color format video sequences, two types of down-sampling filter as shown in Equation 2 and Equation 3 below can be applied to luma samples, both of which have a 2-to-1 down-sampling ratio in the horizontal and vertical directions.

$$f 1 = ( \begin{matrix}0 & 1 & 0 \\ 1 & 4 & 1 \\ 0 & 1 & 0\end{matrix} )$$

$$f 2 = ( \begin{matrix}1 & 2 & 1 \\ 1 & 2 & 1\end{matrix} )$$

Based on a SPS-level flag, the 2-dimensional 6-tap or 5-tap filter is applied to the luma samples within the current block as well as its adjacent luma samples. An SPS-level flag equal to 1 specifies that prediction processes operate in a manner designed for chroma sample positions that are not vertically shifted relative to corresponding luma sample positions, and the 5-tap filter is used; an SPS-level flag equal to 0 specifies that prediction processes operate in a manner designed for chroma sample positions that are shifted downward by 0.5 in units of luma samples relative to corresponding luma sample positions, and the 6-tap filter is used.

An exception applies if the top line of the current block is a CTU boundary: in this case, the one-dimensional 3-tap filter as shown in Equation 4 below is applied to the above adjacent luma samples, to avoid the usage of more than one luma line above the CTU boundary.

$$f 3 = ( \begin{matrix}1 & 2 & 1\end{matrix} )$$

The process of down-sampling using the aforementioned filters can be represented by Equation 5, Equation 6, and Equation 7 below, corresponding to the filters in Equation 2, Equation 3, and Equation 4, respectively.

$${rec}_{L}^{′} ( i , j ) = [ \begin{matrix}{rec}_{L} ( 2 i - 1 , 2 j ) + 2 \cdot {rec}_{L} ( 2 i , 2 j ) + {rec}_{L} ( 2 i + 1 , 2 j ) + \\ {rec}_{L} ( 2 i - 1 , 2 j + 1 ) + 2 \cdot {rec}_{L} ( 2 i , 2 j + 1 ) + {rec}_{L} ( 2 i + 1 , 2 j + 1 ) + 4\end{matrix} ] >> 3$$

$${rec}_{L}^{′} ( i , j ) = [ \begin{matrix}{rec}_{L} ( 2 i , 2 j - 1 ) + {rec}_{L} ( 2 i - 1 , 2 j ) + 4 \cdot {rec}_{L} ( 2 i , 2 j ) + \\ {rec}_{L} ( 2 i + 1 , 2 j ) + {rec}_{L} ( 2 i , 2 j + 1 ) + 4\end{matrix} ] >> 3$$

$${rec}_{L}^{′} ( i , j ) = [ {rec}_{L} ( 2 i - 1 , 2 j ) + 2 \cdot {rec}_{L} ( 2 i , 2 j ) + {rec}_{L} ( 2 i + 1 , 2 j ) + 2 ] >> 2$$

where rec_{L} represents the reconstructed values of the collocated luma samples and rec_{L}′ represents the reconstructed values of the down-sampled collocated luma samples.

The linear model parameters a and B are derived based on reconstructed adjacent chroma samples and their corresponding reconstructed luma samples which are down-sampled for the case of non-4:4:4 color format at both encoder and decoder side to avoid any signaling overhead.

In the initially adopted version of the CCLM mode, the linear minimum mean square error (“LMMSE”) estimator was used for derivation of the parameters by Equation 8 and Equation 9 below:

$$α = \frac{N \cdot {\sum }_{n = 0}^{N - 1} ( {rec}_{C} ( n ) \cdot {rec}_{L}^{′} ( n ) ) - {\sum }_{n = 0}^{N - 1} {rec}_{C} ( n ) \cdot {\sum }_{n = 0}^{N - 1} {rec}_{L}^{′} ( n )}{N \cdot {\sum }_{n = 0}^{N - 1} ( {rec}_{L}^{′} ( n ) \cdot {rec}_{L}^{′} ( n ) ) - {\sum }_{n = 0}^{N - 1} {rec}_{L}^{′} ( n ) \cdot {\sum }_{n = 0}^{N - 1} {rec}_{L}^{′} ( n )}$$

$$β = \frac{{\sum }_{n = 0}^{N - 1} {rec}_{C} ( n ) - α \cdot {\sum }_{n = 0}^{N - 1} {rec}_{L}^{′} ( n )}{N}$$

where

$${rec}_{L}^{′} ( n )$$

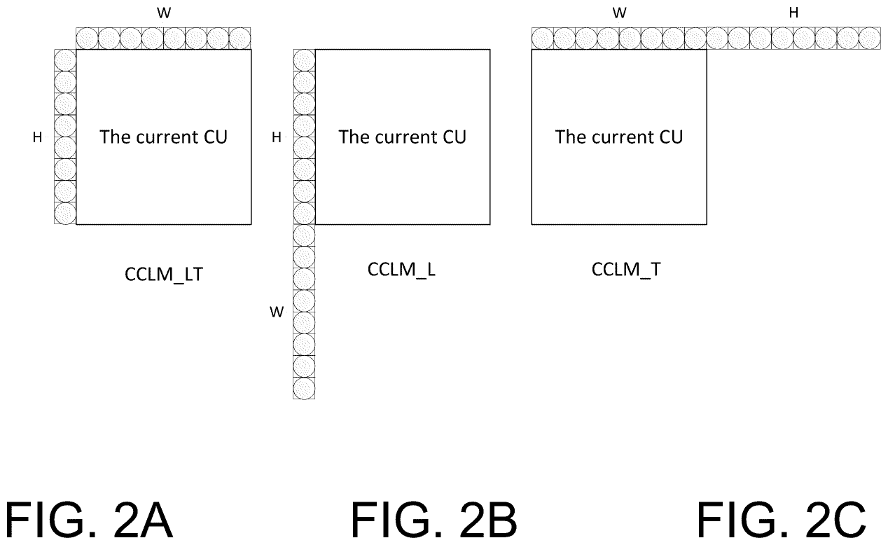

represents the reconstructed values of the down-sampled adjacent luma samples in the reference area, rec_{C}(n) represents the reconstructed values of the adjacent chroma samples in the reference area, and N is the total number of the used adjacent samples. For a W×H chroma CU, the CCLM_LT mode uses the above adjacent W samples and the left adjacent H samples, the CCLM_L mode uses the left adjacent (H+W) samples, and the CCLM_T mode uses the above adjacent (W+H) samples as shown in FIGS. 2A, 2B, and 2C, where the used samples are marked as circles.

In some embodiments, to ensure that the number of the samples used to derive the linear model parameters is a power of 2, some method of increasing or decreasing samples is used.

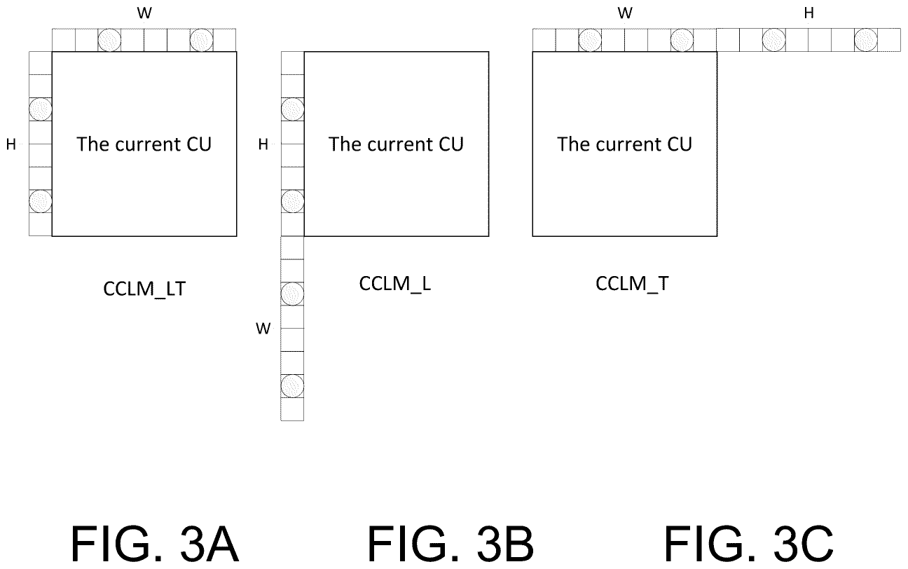

In the final design, however, only four samples are involved to reduce the computational complexity. For a W×H chroma block, the four samples used in the CCLM_LT mode are samples located at the positions of W/4 and 3 W/4 at the top boundary and at the positions of H/4 and 3H/4 at the left boundary. In CCLM_T and CCLM_L modes, the top and left boundary are extended to a size of (W+H) samples, and the four samples used for the model parameter derivation are located at the positions (W+H)/8, 3 (W+H)/8, 5 (W+H)/8 and 7 (W+H)/8. For example, for an 8×8 chroma CU, the used samples are illustrated in FIGS. 3A, 3B, and 3C as circles.

The four reconstructed down-sampled adjacent luma samples at the selected positions are compared four times to derive two smaller values:

$${L}_{min}^{0} and {L}_{min}^{1} ,$$

and two larger values:

$${L}_{max}^{0} and {L}_{max}^{1} .$$

Their corresponding reconstructed chroma sample values are denoted as

$${C}_{min}^{0} , {C}_{min}^{1} , {C}_{max}^{0} and {C}_{max}^{1} .$$

Then Lₘᵢₙ, Lₘₐₓ, Cₘᵢₙ and Cₘₐₓ are derived as Equations 10, 11, 12, and 13 below:

$${L}_{min} = ( {L}_{min}^{0} + {L}_{min}^{1} + 1 ) >> 1$$

$${L}_{max} = ( {L}_{max}^{0} + {L}_{max}^{1} + 1 ) >> 1$$

$${C}_{min} = ( {C}_{min}^{0} + {C}_{min}^{1} + 1 ) >> 1$$

$${C}_{max} = ( {C}_{max}^{0} + {C}_{max}^{1} + 1 ) >> 1$$

Finally, the linear model parameters a and B are obtained according to Equation 14 and Equation 15 below:

$$α = \frac{{C}_{max} - {C}_{min}}{{L}_{max} - {L}_{min}}$$

$$β = {C}_{min} - α \cdot {L}_{min}$$

The division operation to calculate parameter a is implemented with a look-up table. To reduce the memory required for storing the table, the diff value (difference between maximum and minimum values) and the parameter a are expressed by an exponential notation. For example, diff is approximated with a 4-bit significant part and an exponent. Consequently, the table for 1/diff is reduced into 16 elements for 16 values of the significand as follows:

$$DivTable [ ] = \{ 0 , 7 , 6 , 5 , 5 , 4 , 4 , 3 , 3 , 2 , 2 , 1 , 1 , 1 , 1 , 0 \}$$

This would have a benefit of both reducing the complexity of the calculation as well as the memory size required for storing the needed tables.

Furthermore, ECM extends the VVC implementation of CCLM by introducing multi-models for a CU. The samples within a CU are divided into different groups and each group has a linear model for prediction. Dependent on the adjacent reconstructed samples used in model derivation, multi-model CCLM (“MM-CCLM”) also have different modes: MMLM_LT, MMLM_L and MMLM_T. The difference among the three modes is the same as the difference among CCLM_LT, CCLM_L and CCLM_T modes: the locations of the reconstructed adjacent samples that are used for linear model parameters (α and β) derivation.

In each MM-CCLM mode, there can be more than one linear model relating luma and chroma in a block. First, the reconstructed adjacent samples are classified into two classes using a multi-model threshold which is the average of the values of the luma reconstructed adjacent samples. Then each class is treated as an independent training set to derive a linear model, using the aforementioned LMMSE method. Subsequently, the reconstructed luma samples of the current block are also classified based on the same rule. Finally, the chroma samples are predicted by the reconstructed luma samples differently in different classes.

Extending the two-parameter CCLM model mapping luma values to chroma values (as described by Equation 1 above), ECM includes signaling of an adjustment “u” to the slope parameter, updating the model to the following form, represented by Equations 16, 17, and 18:

$${pred}_{C} ( i , j ) = {α}^{′} \cdot {rec}_{L}^{′} ( i , j ) + β$$

$${α}^{′} = a + u$$

$${β}^{′} = {β}^{′} - u * {y}_{r}$$

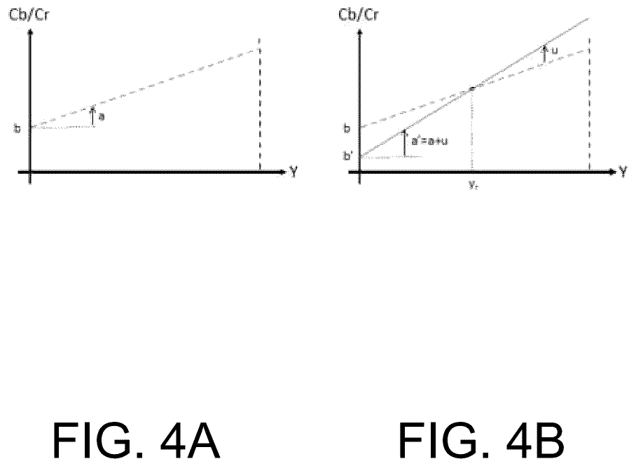

With this selection the mapping function is tilted or rotated around the point with luminance value yᵣ. The average of the reconstructed adjacent luma samples used in the model creation as yᵣ in order to provide a meaningful modification to the model. FIGS. 4A and 4B illustrate slope adjustment of a CCLM model.

Slope adjustment parameter u is provided as an integer between −4 and 4, inclusive, and signaled in the bitstream. The unit of the slope adjustment parameter is ⅛th of a chroma sample value per one luma sample value (for 10-bit color depth content).

Slope adjustment is available for the CCLM_LT and MMLM_LT modes. This selection is based on coding efficiency vs. complexity trade-off considerations.

When slope adjustment is applied for a multimode CCLM model, both models can be adjusted and thus up to two slope updates are signaled for a single chroma block.

Furthermore, ECM provides a convolutional cross-component model (“CCCM”) applied to predict chroma samples from reconstructed luma samples in a similar fashion as the CCLM modes. As with CCLM, the reconstructed luma samples are down-sampled to match the lower resolution chroma grid when chroma sub-sampling is used. Similar to CCLM, top, left or top and left adjacent samples are used as templates for model derivation.

Also, similarly to CCLM, CCCM provides a single model variant and a multi-model variant. The multi-model variant uses two models: one model derived for samples above the average of adjacent luma value, and another model for the rest of the samples (similar to the CCLM design).

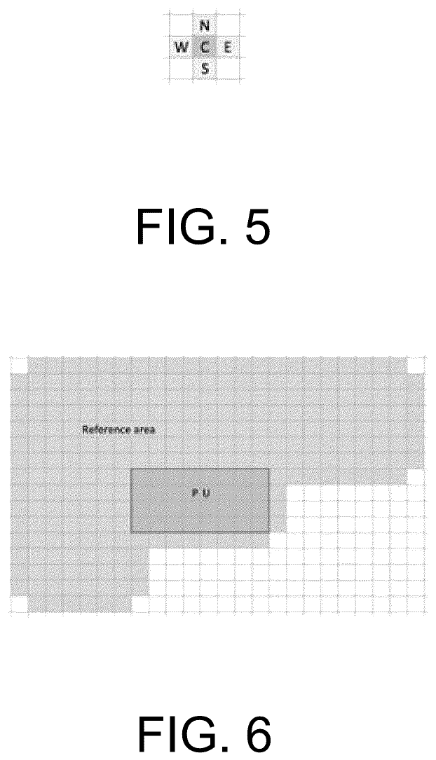

CCCM implements a convolutional 7-tap filter, composed of a cross-shaped 5-tap spatial component, a nonlinear term, and a bias term. The input to the spatial 5-tap component of the filter includes of a center (“C”) luma sample which is collocated with the chroma sample to be predicted and its above/north (“N”), below/south (“S”), left/west (“W”) and right/east (“E”) neighbors as illustrated by FIG. 5.

The nonlinear term P is represented as power of two of the center luma sample C and scaled to the sample value range of the content by Equation 19 below:

$$P = ( C * C + midVal ) >> bitDepth$$

That is, for 10-bit color depth content it is calculated by Equation 20 below:

$$P = ( C * C + 5 \; 12 ) >> 10$$

The bias term B represents a scalar offset between the input and output (similarly to the bias term β in CCLM) and is set to a midpoint chroma value (e.g., 512 for 10-bit color depth content).

Output of the filter is calculated as a convolution between the filter coefficients cᵢ and the input values and clipped to the range of valid chroma samples by Equation 21 below:

$${pred}_{C} ( i , j ) = {c}_{0} * C + {c}_{1} * N + {c}_{2} * S + {c}_{3} * E + {c}_{4} * W + {c}_{5} * P + {c}_{6} * B$$

The filter coefficients cᵢ are calculated by minimizing mean square error (“MSE”) between predicted and reconstructed chroma samples in the reference area. FIG. 6 illustrates a reference area which includes 2 or 6 lines of chroma samples above and left of the PU. Whether to use 6 lines or 2 lines of adjacent samples to derive the CCCM model parameters in the single model CCCM is determined by a template cost. Similarly, for a multi-model CCCM (“MM-CCCM”) mode, the two candidates use 6 lines adjacent luma samples or luma samples collocated to the current chroma block to derive mean values which separate samples into two groups. The cost is derived by applying a cross-component prediction (“CCP”) candidate (either 2 or 6 lines) on a template, calculating the sum of absolute difference (“SAD”) between CCP predicted samples and reconstructed samples in the template.

In the event that the matching block is at a boundary of a picture, slice, or tile, adjacent samples on an entire side may not exist. Furthermore, even if upper-adjacent and left-adjacent samples have been encoded or decoded before the PU, right-adjacent and lower-adjacent samples may not be encoded or decoded before the current coding block according to raster scanning order. Other possible coding orders may also change the availability of adjacent samples at the entirety of an upper, left, right, or lower edge. Thus, the present disclosure will refer to nonexistent or non-encoded and non-decoded adjacent samples along an edge as “not available.”

Thus, the reference area of FIG. 6 further extends one PU width to the right and one PU height below the PU boundaries. The reference area is adjusted to include only available samples. The reference area extensions shaded in blue support the samples at the extremities of the cross-shaped spatial filter, and are padded when in non-available areas.

MSE minimization is performed by calculating an autocorrelation matrix for the luma input and a cross-correlation vector between the luma input and chroma output. The autocorrelation matrix is LDL-decomposed and the final filter coefficients are calculated by back-substitution.

The autocorrelation matrix is calculated using the reconstructed values of luma and chroma samples. These samples are full-range (e.g., between 0 and 1023 for 10-bit color depth content) resulting in relatively large values in the autocorrelation matrix. This requires high bit depth operation during model parameter calculation.

It is proposed to remove fixed offsets from luma and chroma samples in each PU for each model, driving down the magnitudes of the values used in the model creation and allowing reducing the precision needed for the fixed-point arithmetic. As a result, 16-bit decimal precision is proposed to be used instead of the 22-bit precision of the original CCCM implementation.

Reference sample values just outside of the top-left corner of the PU are used as the offsets (offsetLuma, offsetCb and offsetCr) for simplicity. The samples values used in both model creation and final prediction (i.e., luma and chroma in the reference area, and luma in the current PU) are reduced by these fixed values by Equations 22, 23, 24, 25, 26, 27, and 28 below:

$${C}^{′} = C - offsetLuma$$

$${N}^{′} = N - offsetLuma$$

$${S}^{′} = S - offsetLuma$$

$${E}^{′} = E - offsetLuma$$

$${W}^{′} = W - offsetLuma$$

$${P}^{′} = {C}^{′} * {C}^{′}$$

$$B = midVal = 1 << ( bitDepth - 1 )$$

and the chroma value is predicted by Equation 29 below, where offsetChroma is equal to offsetCr and offsetCb for Cr and Cb components, respectively.

$${pred}_{C} ( i , j ) = {c}_{0} * {C}^{′} + {c}_{1} * {N}^{′} + {c}_{2} * {S}^{′} {c}_{3} * {E}^{′} + {c}_{4} * {W}^{′} + {c}_{5} * {P}^{′} + {c}_{6} * {B}^{′} + offsetChroma$$

To avoid additional sample-level operations, the luma offset is removed during the luma reference sample interpolation. For example, the rounding term used in the luma reference sample interpolation can be substituted with an updated offset including both the rounding term and the offsetLuma. The chroma offset can be removed by deducting the chroma offset directly from the reference chroma samples. Alternatively, impact of the chroma offset can be removed from the cross-component vector giving identical result. To add the chroma offset back to the output of the convolutional prediction operation, the chroma offset is added to the bias term of the convolutional model.

The process of CCCM model parameter calculation requires division operations, which are not always implementation-friendly. The division operations are implemented by a multiplication (with a scale factor) operation and a shift operation, where scale factor and number of shifts are calculated based on denominator similar to the method used in calculation of CCLM parameters.

This CCCM mode can be denoted as a default CCCM mode according to the present disclosure.

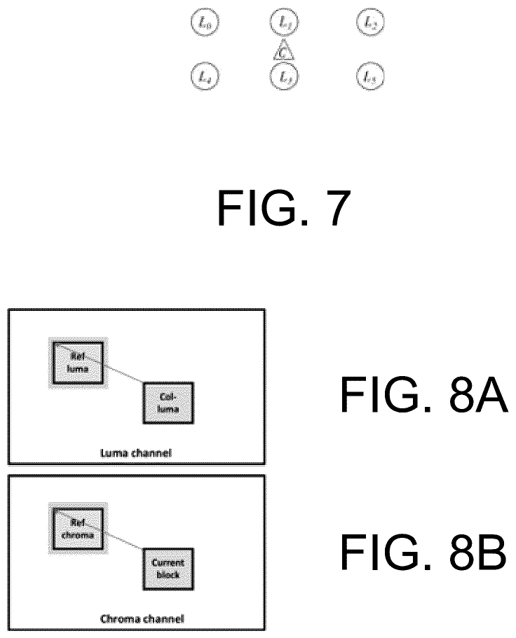

Furthermore, ECM provides a CCCM mode with a 3×2 filter using non-down-sampled luma samples (“NS-CCCM”), the 3-2 filter including 6-tap spatial terms, four nonlinear terms and a bias term. The 6-tap spatial terms correspond to 6 luma samples (i.e., L0, L1, . . . , L5) around the chroma sample (i.e., C or pred_{C}(i,j)) to be predicted, the four non-linear terms are derived from the samples L0, L1, L2, and L3 as illustrated by FIG. 7, by Equation 30 below:

$${pred}_{C} ( i , j ) = {\sum }_{i = 0}^{5} {α}_{i} \cdot ( {L}_{i} ) + {\sum }_{i = 6}^{9} {α}_{i} \cdot ( ( {( {L}_{i - 4} )}^{2} + β ) >> bitDepth + {α}_{10} \cdot β$$

Herein, αᵢ is the coefficient and β is the offset. Similarly to the CCCM design, up to 6 lines/columns of chroma samples above and left to the current CU are applied to derive the filter coefficients. The filter coefficients are derived based on the same LDL decomposition method used in CCCM. The proposed method is signaled as an additional CCCM model besides the existing one, when the CCCM is selected, one single flag is signaled and used for both two chroma components to indicate whether the default CCCM model or the NS-CCCM model is applied. Additionally, SPS signaling is introduced to indicate whether the NS-CCCM is enabled.

Similar to the default CCCM mode, reference sample values just outside of the top-left corner of the PU are used as the offsets (offsetLuma, offsetChroma) for simplicity, and the chroma value is predicted by Equation 31 below:

$${pred}_{C} ( i , j ) = {\sum }_{i = 0}^{5} {α}_{i} \cdot ( {L}_{i} - offsetLuma ) + {\sum }_{i = 6}^{9} {α}_{i} \cdot ( ( {( {L}_{i - 4} - offsetLuma )}^{2} + β ) >> bitDepth ) + {α}_{10} \cdot β + offsetChroma$$

ECM further provides a block-vector guided CCM (“BVG-CCCM”) mode. When the co-located luma prediction is coded with IBC or IntraTMP in Intra slices, the BVG-CCCM mode can be used. In this mode, the block vectors of the co-located luma blocks, coded in IBC or intraTMP modes, are used to determine the reference area for calculating the CCCM parameters. The prediction is performed using uses the calculated model parameters and co-located luma samples. FIG. 8A and FIG. 8B illustrate a reference area in the luma and chroma channels, respectively, according to BVG-CCCM.

The BVG-CCCM mode implements an 11-tap filter for cross-component prediction by Equation 32 below:

$${pred}_{C} ( i , j ) = {c}_{0} * C + {c}_{1} * N + {c}_{2} * S + {c}_{3} * E + {c}_{4} * W + {c}_{5} * P ( C ) + {c}_{6} * P ( N ) + {c}_{7} * P ( S ) + {c}_{8} * P ( W ) + {c}_{9} * P ( E ) + {c}_{10} * B$$

The input to the spatial 5-tap component of the filter includes a center (“C”) luma sample which is collocated with the chroma sample to be predicted and its above/north (“N”), below/south (“S”), left/west (“W”) and right/east (“E”) neighbors as illustrated previously with reference to FIG. 5. The nonlinear term P is represented as power of two of the corresponding luma sample and B is the bias term.

Similar to the default CCCM mode, reference sample values just outside of the top-left corner of the PU are used as the offsets (offsetLuma, offsetChroma) for simplicity, and the chroma value is predicted by Equation 33 below:

$${pred}_{C} ( i , j ) = {c}_{0} * {C}^{′} + {c}_{1} * {N}^{′} + {c}_{2} * {S}^{′} + {c}_{3} * {E}^{′} + {c}_{4} * {W}^{′} + {c}_{5} * P ( {C}^{′} ) + {c}_{6} * P ( {N}^{′} ) + {c}_{7} * P ( {S}^{′} ) + {c}_{8} * P ( {W}^{′} ) + {c}_{9} * P ( {E}^{′} ) + {c}_{10} * B + offsetChroma$$

where C′, N′, S′, E′ and W′ can be calculated according to the equations above. BVG-CCCM further implements parameter calculation by determining a reference area based on scanning five locations in the collocated luma block area and deriving the associated block vectors.

ECM further provides a gradient and location-based CCCM model (“GL-CCCM”) mode. According to GL-CCCM, luma values are mapped to chroma values using a filter with inputs including one spatial luma sample, two gradient values, two location information, a nonlinear term, and a bias term. The GL-CCCM method uses gradient and location information instead of the 4 spatial neighbor samples used in the CCCM filter. The GL-CCCM filter used for the prediction is according to Equation 34 below:

$${pred}_{C} ( i , j ) = {c}_{0} C + {c}_{1} {G}_{y} + {c}_{2} {G}_{x} + {c}_{3} y + {c}_{4} X + {c}_{5} P + {c}_{6} B$$

where the Y and X are the spatial coordinates of the center luma sample, and G_{y} and Gₓ are the vertical and horizontal gradients, respectively, and are calculated by Equations 35 and 36 below:

$${G}_{y} = ( 2 N + NW + N E ) - ( 2 S + SW + SE )$$

$${G}_{x} = ( 2 W + NW + SW ) - ( 2 E + NE + SE )$$

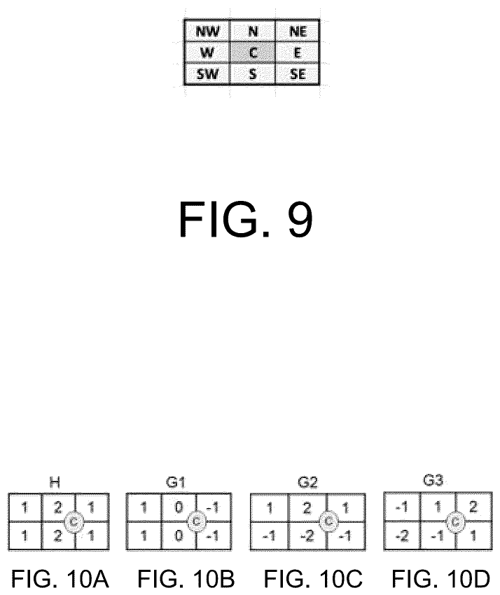

FIG. 9 illustrates spatial samples referenced in GL-CCCM. Similar to the default CCCM mode, reference sample values just outside of the top-left corner of the PU can be used as the offsets (offsetLuma, offsetChroma) for simplicity, and the chroma value is predicted by Equation 37 below:

$${pred}_{C} ( i , j ) = {c}_{0} {C}^{′} + {c}_{1} {G}_{y} + {c}_{2} {G}_{x} + {c}_{3} y + {c}_{4} X + {c}_{5} {P}^{′} + {c}_{6} B + offsetChroma$$

where C′ and P′ can be calculated according to the equations above.

Usage of GL-CCCM is signaled with a CABAC coded PU-level flag. GL-CCCM is signaled as a sub-mode of CCCM: the GL-CCCM flag is only signaled if the original CCCM flag is true.

Similar to CCCM, GL-CCCM implements six modes for calculating the parameters: single-model GL-CCCM from above and left templates; single-model GL-CCCM from an above template; single-model GL-CCCM from a left template; multi-model GL-CCCM from above and left templates; multi-model GL-CCCM from an above template; and multi-model GL-CCCM from a left template.

ECM further provides a CCCM mode with multiple down-sampling filters (“MDF-CCCM”). MDF-CCCM provides multiple down-sampling filters applied to a group of reconstructed luma samples in CCCM. The linear combination of these down-sampled reconstructed samples is multiplied by derived filter coefficients to form the final chroma predictor. The horizontal or vertical location of the center luma sample are also considered in the tested model. The cross-component models shown in the three subsequent Equations 38, 39, and 40 are tested as 3 additional MDF-CCCM modes with a mode index signaled in the bitstream:

$${pred}_{C} ( i , j ) = {c}_{0} H ( C ) + {c}_{1} {G}_{1} ( C ) + {c}_{2} {G}_{2} ( C ) + {c}_{3} {G}_{3} ( C ) + {c}_{4} P ( H ( C ) ) + {c}_{5} P ( {G}_{1} ( C ) ) + {c}_{6} P ( {G}_{2} ( C ) ) + {c}_{7} X + {c}_{8} Y + {c}_{9} B$$

$${pred}_{C} ( i , j ) = {c}_{0} H ( C ) + {c}_{1} H ( W ) + {c}_{2} H ( E ) + {c}_{3} {G}_{1} ( C ) + {c}_{4} {G}_{1} ( W ) + {c}_{5} {G}_{1} ( E ) + {c}_{6} P ( H ( C ) ) + {c}_{7} P ( H ( E ) ) + {c}_{8} P ( H ( W ) ) + {c}_{9} X + {c}_{10} B$$

$${pred}_{C} ( i , j ) = {c}_{0} H ( C ) + {c}_{1} H ( NE ) + {c}_{2} H ( SW ) + {c}_{3} {G}_{1} ( C ) + {c}_{4} {G}_{1} ( NE ) + {c}_{5} {G}_{1} ( ESW ) + {c}_{6} P ( H ( C ) ) + {c}_{7} P ( H ( NE ) ) + {c}_{8} P ( H ( SW ) ) + {c}_{9} Y + {c}_{10} B$$

where H(⋅), G1(⋅), G2(⋅), G3(⋅) are various down-sampling filters as illustrated in FIGS. 10A through 10D, C denotes the current chroma sample position, N, S, W, E, NE, SW are the positions around C as illustrated in FIGS. 10A through 10D, cᵢ are filter coefficients, P and B are a nonlinear term and a bias term, and X and Y are the horizontal and vertical locations of the center luma sample with respect to the top-left coordinates of the block. Similar to the default CCCM mode, reference sample values just outside of the top-left corner of the PU can be used as the offsets (offsetLuma, offsetChroma) for simplicity.

ECM further provides a Gradient Linear Model (“GLM”) mode. Compared with CCLM, instead of down-sampling the reconstructed luma samples, the GLM utilizes luma sample gradients to derive the linear model. In other words, rather than using the filters in Equation 2, Equation 3, and Equation 4 above, a gradient G is applied in the CCLM process. The other designs of CCLM (e.g., parameter derivation, prediction sample linear transform) are kept unchanged.

Two modes of GLM are supported: a two-parameter GLM mode and a three-parameter GLM mode.

Compared with the CCLM, instead of down-sampled luma values, the two-parameter GLM utilizes luma sample gradients to derive the linear model represented by Equation 41 below. Specifically, when the two-parameter GLM is applied, the input to the CCLM process, i.e., the down-sampled luma samples L, are replaced by luma sample gradients G. The other parts of the CCLM (e.g., parameter derivation, prediction sample linear transform) are kept unchanged.

$${pred}_{C} ( i , j ) = α \cdot G + β$$

In the three-parameter GLM represented by Equation 42 below, a chroma sample can be predicted based on both the luma sample gradients and down-sampled luma values with different parameters. The model parameters of the three-parameter GLM are derived from 6 rows and columns of adjacent samples by the LDL decomposition-based MSE minimization method as used in CCCM.

$${pred}_{C} ( i , j ) = {α}_{0} \cdot G + {α}_{1} \cdot L + {α}_{2} \cdot β$$

Similar to the default CCCM mode, reference sample values just outside of the top-left corner of the PU are used as the offsets (offsetLuma, offsetChroma) for simplicity, and the chroma value is predicted by Equation 43 below:

$${pred}_{C} ( i , j ) = {α}_{0} \cdot G + {α}_{1} \cdot ( L - offsetLuma ) + {α}_{2} \cdot β + offsetChroma$$

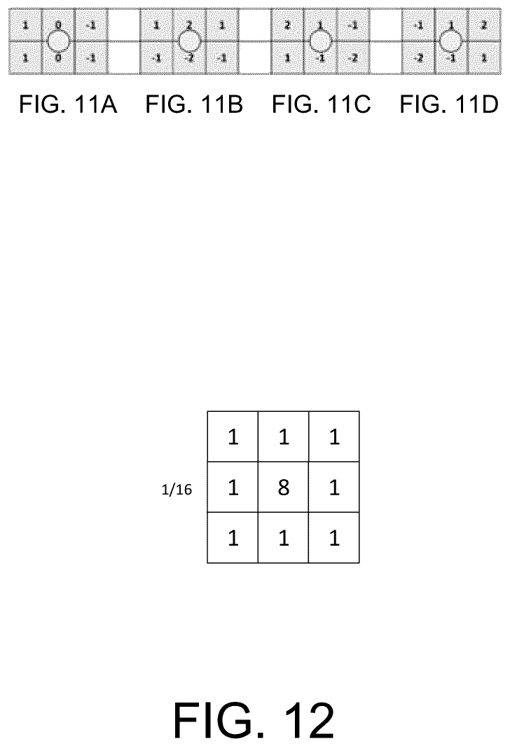

The gradient G can be calculated by one of four Sobel-based gradient patterns illustrated by FIGS. 11A through 11D, represented by the following matrices represented by Equations 44, 45, 46, and 47:

$$g 1 = ( \begin{matrix}1 & 0 & - 1 \\ 1 & 0 & - 1\end{matrix} )$$

$$g 2 = ( \begin{matrix}1 & 2 & 1 \\ - 1 & - 2 & - 1\end{matrix} )$$

$$g 3 = ( \begin{matrix}2 & 1 & - 1 \\ 1 & - 1 & - 2\end{matrix} )$$

$$g 4 = ( \begin{matrix}- 1 & 1 & 2 \\ - 2 & - 1 & 1\end{matrix} )$$

Each of these matrices yields, respectively, one of the following Equations 48, 49, 50, and 51 for calculating the gradient G:

$${G}_{L} ( i , j ) = {rec}_{L} ( 2 i - 1 , 2 j ) - {rec}_{L} ( 2 i + 1 , 2 j ) + {rec}_{L} ( 2 i - 1 , 2 j + 1 ) - {rec}_{L} ( 2 i + 1 , 2 j + 1 )$$

$${G}_{L} ( i , j ) = {rec}_{L} ( 2 i - 1 , 2 j ) + 2 \cdot {rec}_{L} ( 2 i , 2 j ) + {rec}_{L} ( 2 i + 1 , 2 j ) - {rec}_{L} ( 2 i - 1 , 2 j + 1 ) - 2 \cdot {rec}_{L} ( 2 i , 2 j + 1 ) - {rec}_{L} ( 2 i + 1 , 2 j + 1 )$$

$${G}_{L} ( i , j ) = {rec}_{L} ( 2 i - 1 , 2 j ) + {rec}_{L} ( 2 i , 2 j ) - {rec}_{L} ( 2 i + 1 , 2 j ) + {rec}_{L} ( 2 i - 1 , 2 j + 1 ) - {rec}_{L} ( 2 i , 2 j + 1 ) - 2 \cdot {rec}_{L} ( 2 i + 1 , 2 j + 1 )$$

$${G}_{L} ( i , j ) = - {rec}_{L} ( 2 i - 1 , 2 j ) + {rec}_{L} ( 2 i , 2 j ) + 2 \cdot {rec}_{L} ( 2 i + 1 , 2 j ) - {rec}_{L} ( 2 i - 1 , 2 j + 1 ) - {rec}_{L} ( 2 i , 2 j + 1 ) + {rec}_{L} ( 2 i + 1 , 2 j + 1 )$$

ECM further provides fusion of two chroma intra prediction signals (subsequently “chroma fusion”). One of the two chroma intra prediction signals is predicted using one of: derived mode (“DM”), decoder-side intra mode derivation (“DIMD”) chroma mode, and the four default modes (non-linear model modes, or “non-LM modes”). The other chroma intra prediction signal is predicted using cross-component linear prediction modes (“LM modes”). Two different methods are supported.

By a first chroma fusion method, the LM mode can be either MM-CCLM or MM-CCCM, and the final predictor is derived by Equation 52 below:

$${pred}_{C} ( i , j ) = ( w 0 \times pred 0 ( i , j ) + w 1 \times pred 1 ( i , j ) + ( 1 << ( shift - 1 ) ) ) >> shift$$

where pred0(i,j) is the predictor obtained by applying the non-LM mode, pred1(i,j) is the predictor obtained by applying the LM mode and pred_{C}(i,j) is the final predictor of the current chroma block. The two weights w0 and w1 are determined by the intra prediction mode of adjacent chroma blocks and shift is set equal to 2. Specifically, when the above and left adjacent blocks are both coded with LM modes, {w0,w1}={1, 3}; when the above and left adjacent blocks are both coded with non-LM modes, {w0,w1}={3, 1}; otherwise, {w0,w1}={2, 2}. Two template costs are calculated by fusing the angular chroma prediction with MM-CCLM or MM-CCCM, respectively, and the one of the two CCPs which provides a smaller template cost is utilized to derive pred1.

By a second chroma fusion method, the LM mode can be either MM-CCLM or CCLM mode, and the final predictor is derived by Equation 53 below:

$${pred}_{C} ( i , j ) = {α}_{0} \times pred 0 ( i , j ) + {α}_{1} \times {rec}_{L}^{′} ( i , j ) + {α}_{2} \times β$$

where pred0(i,j) is the predictor obtained by applying the non-LM mode,

$${rec}_{L}^{′} ( i , j )$$

is the set of down-sampled reconstructed luma samples at co-located positions and pred_{C}(i,j) is the final predictor of the current chroma block. β is a fixed value and is set equal to 512 for 10-bit color depth content. The three weights α₀, α₁ and α₂ are derived from the adjacent luma and chroma samples using the same LDL derivation method as in CCCM.

For the syntax design, one index is signaled to indicate whether chroma fusion is applied and which method is used as shown in Table 1.

| Index value | Name |
|---|---|
| 0 | No fusion |
| 1 | First chroma fusion method |
| 2 | Second chroma fusion method with |
| | single model |
| 3 | Second chroma fusion method with |
| | multi model |

It is noted that for I slices, the non-LM mode can be DM mode, DIMD chroma mode and the four default modes. For non-I slices, only DIMD chroma mode may be fused with LM modes.

Furthermore, prediction samples of MM-CCLM/MM-CCCM can be filtered with neighbouring samples. As illustrated in FIG. 12, a 3×3 low-pass filter is applied to filter prediction samples generated by MM-CCLM/MM-CCCM. For a sample at a top/left boundary, the filtering window may involve neighbouring reconstructed samples. For inner samples, the filtering window only involves prediction samples, which may be padded. A flag is signaled to indicate whether filtering is applied or not for a block coded with MM-CCLM/MM-CCCM.

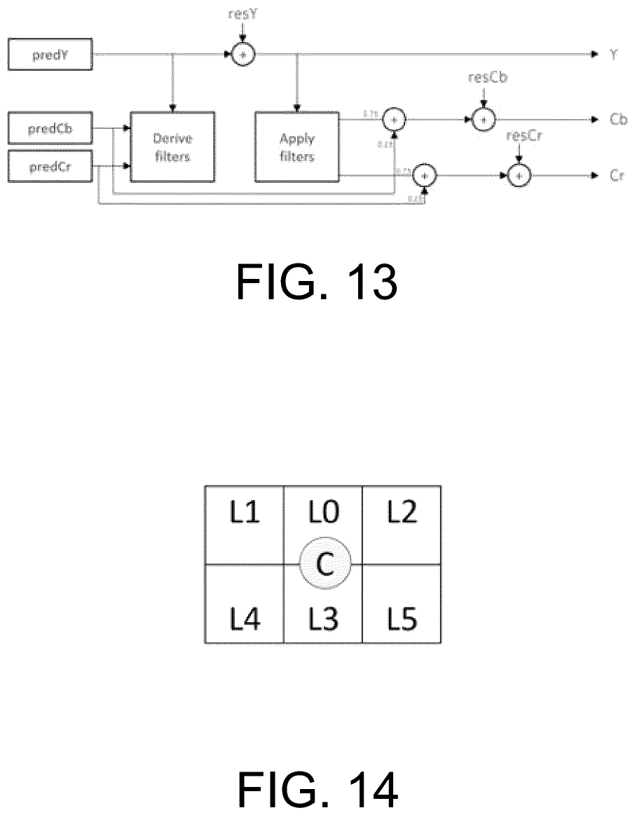

Furthermore, according to a CCCM inter-prediction (“interCCCM”) model, CCCM is applied for predicting chroma samples from reconstructed luma samples when the CU uses inter prediction or intra block copy (IBC). FIG. 13 illustrates interCCCM as implemented by a VVC-standard decoder. Cross-component filters are derived using the prediction blocks of luma and chroma. The derived filters are applied to the reconstructed luma block and blended with the prediction blocks of chroma to produce the final chroma prediction blocks. In the blending process, the filtered reconstructed luma blocks are weighted by a blending weight of 0.75 and chroma prediction blocks are weighted by a blending weight of 0.25.

The 8-tap filter consist of 6 spatial luma samples, a nonlinear term, and a bias term. The spatial luma samples (L0, . . . , L5) are obtained from the luma grid selecting the six luma samples closest to the chroma position C without down-sampling as illustrated by FIG. 14. The predicted chroma value is obtained by Equation 54 below:

$${pred}_{cccm} ( i , j ) = {c}_{0} {L}_{0} + {c}_{1} {L}_{1} + {c}_{2} {L}_{2} + {c}_{3} {L}_{0} + {c}_{4} {L}_{4} + {c}_{5} {L}_{5} + {c}_{6} P ( ( {L}_{0} + {L}_{3} + 1 ) >> 1 ) + {c}_{7} B$$

where P( ) is CCCM's nonlinear operator and B is bias. The filter coefficients are derived using a division-free Gaussian elimination method and the necessary offsets are applied to samples prior to filter derivation. The offsets for division-free Gaussian elimination method are obtained using a four-point average of the luma and chroma prediction blocks, where the four points correspond to the top-left, top-right, bottom-left and bottom-right corners of the blocks. For filter coefficient derivation, at most 256 chroma samples are used.

The final chroma prediction blocks can be obtained by Equation 55 below:

$${pred}_{final} ( i , j ) = ( 3 * {pred}_{cccm} ( i , j ) + 1 * {pred}_{lnter} ( i , j ) + 2 ) >> 2$$

where pred_{cccm}(i,j) is the prediction blocks of chroma obtained by using the interCCCM filter and pred_{cccm}(i,j) is the prediction blocks of chroma obtained by the original inter mode or IBC mode.

Usage of the mode is signalled with a CABAC coded TU level flag. One new CABAC context was included to support this. The interCCCM flag is only signalled if the TU's luma Cbf is non-zero and the CU's predMode is either MODE_INTER or MODE_IBC.

Furthermore, a cross-component prediction (“CCP”) merge mode for intra block (“intra-CCP merge”) is provided. For chroma coding, a flag is signaled to indicate whether a CCP mode (including the CCLM, CCCM, GLM and their variants) or non-CCP mode (conventional chroma intra prediction mode, chroma fusion mode) is used. If the CCP mode is selected, one more flag is signaled to indicate how to derive the CCP type and parameters, i.e., either from a CCP merge list or signaled/derived on-the-fly. In intra-CCP merge mode, the CCP models including the models from CCLM, MMLM, CCCM, GLM, chroma fusion and CCP merge modes are stored and used in constructing a CCP merge candidate for the later-coded chroma intra blocks. The CCP merge candidate list is constructed from the spatial adjacent, temporal, spatial non-adjacent, history-based or shifted temporal candidates. Each CCP merge candidate indicates a CCP model. After including these CCP merge candidates, default models are further included to fill the remaining empty positions in the CCP merge candidate list. In order to remove redundant CCP models in the CCP merge candidate list, pruning operation is applied. After constructing the CCP merge candidate list, the CCP merge candidates in the CCP merge candidate list are reordered depending on the SAD costs, which are obtained using a template of top, left, or top and left adjacent samples to the current block.

The positions and inclusion order of the spatial adjacent and non-adjacent candidates are the same as those defined in ECM for regular inter merge prediction candidates. Temporal candidates are selected from the collocated picture. The position and inclusion order of the temporal candidates are, likewise, the same as those defined in ECM for regular inter merge prediction candidates. The shifted temporal candidates are also selected from the collocated picture. The position of temporal candidates is shifted by a selected motion vector which is derived from motion vectors of neighboring blocks. A history-based table is maintained to include the recently used CCP models, and the table is reset at the beginning of each CTU row. If the current CCP merge candidate list is not full after including spatial adjacent and non-adjacent candidates, the CCP models in the history-based table are added to the CCP merge candidate list. CCLM candidates with default scaling parameters are considered, only when the CCP merge candidate list is not full after including the spatial adjacent, spatial non-adjacent, or history-based candidates. If the current CCP merge candidate list has no candidates with the single model CCLM mode, the default scaling parameters are {0, 1/8, −1/8, 2/8, −2/8, 3/8, −3/8, 4/8, −4/8, 5/8, −5/8, 6/8}. Otherwise, the default scaling parameters are {0, the scaling parameter of the first CCLM candidate+{1/8, −1/8, 2/8, −2/8, 3/8, −3/8, 4/8, −4/8, 5/8, −5/8, 6/8}}.

A flag is signaled to indicate whether the intra-CCP merge mode is applied or not. If intra-CCP merge mode is applied, an index is signaled to indicate which candidate model is used by the current block. In addition, intra-CCP merge mode is not allowed for the current chroma coding block when the current CU is coded by intra sub-partitions (ISP) with one coding tree, or the current chroma coding block size is less than or equal to 16.

Furthermore, the intra-CCP merge mode is extended to chroma inter coding, and a CCP merge mode for inter block (“inter-CCP merge”) mode is provided. The CCP models including CCLM, MMLM, CCCM, GLM, chroma fusion, CCP merge modes, and interCCCM are stored and inherited for the later-coded chroma intra and inter blocks. Similar to the CCP merge mode for chroma intra blocks, a flag is signaled to indicate whether a chroma inter block is coded using this mode. If the inter-CCP merge mode is used, a CCP merge candidate list is constructed in a similar way as that for chroma intra blocks except that additional shifted temporal candidate and on-the-fly derived candidates are included in the CCP merge candidate list. The additional shifted temporal candidates are derived from the collocated picture. The position of these candidates are the same as those defined in ECM for regular inter merge prediction candidates with a shift obtained from the motion vector of the current block. The on-the-fly derived candidates are obtained using the neighboring reconstructed samples of the current block. At most one on-the-fly derived candidate (single-model CCCM) is added to the CCP merge candidate list for low-delay pictures. After the CCP merge candidate list is constructed, the CCP merge candidates in the CCP merge candidate list having lowest template costs are selected to predict the chroma block. Similar to interCCCM mode, the chroma prediction block obtained by using the selected CCP model is blended with chroma prediction block obtained by the inter mode to yield the final chroma prediction block by Equation 56 below:

$${pred}_{final} ( i , j ) = ( 3 * {pred}_{ccp} ( i , j ) + 1 * {pred}_{lnter} ( i , j ) + 2 ) >> 2$$

According to the present disclosure, a “CCP mode” should be understood as including intra-CCP mode and inter-CCP mode, and a “CCP merge mode” should be understood as including intra-CCP merge mode and inter-CCP merge mode.

For a chroma block coded by chroma fusion mode with the first chroma fusion method as described above with reference to Table 1, the used CCP model is stored and can be used for later-coded chroma blocks coded by a CCP merge mode. However, non-CCP prediction information and fusion information are ignored and cannot provide guidance for later-coded chroma blocks. Considering such additional information for later-coded chroma blocks may improve prediction accuracy.

Therefore, example embodiments of the present disclosure provide chroma fusion inheritance in CCP merge modes.

For a chroma block coded by a CCP mode, the used CCP model is stored and can be used for later-coded chroma blocks coded by a CCP merge mode. However, the CCP model derived by the template or inherited from coded blocks is not necessarily the optimal model to describe the relationship between luma and chroma of the current block. Using the reconstructed samples within the current block may yield a more accurate CCP model which can be used for later-coded chroma blocks coded by a CCP merge mode. Moreover, for a non-CCP mode-coded block, the reconstructed samples can also be used within the current block to construct a CCP model and used for later-coded chroma blocks coded by a CCP merge mode.

Therefore, example embodiments of the present disclosure provide updating a CCP model by a current reconstructed block.

For interCCCM mode and inter-CCP merge mode, chroma fusion is performed with a fixed fusion weight which is not necessarily suitable for every chroma block. An extended fusion weight list may improve prediction accuracy.

Therefore, example embodiments of the present disclosure provide adaptive chroma fusion for interCCCM mode and inter-CCP merge mode; and further provide adaptive model derivation for interCCCM mode.

According to an example embodiment of chroma fusion inheritance of the present disclosure, for a chroma block coded by chroma fusion mode with the first chroma fusion method described above with reference to Table 1, the CCP model, the non-CCP mode and the fusion weight are stored and used in constructing a CCP merge candidate list for later-coded chroma blocks coded by any CCP merge mode. Therefore, a CCP merge candidate derived from a chroma block coded by chroma fusion mode can include a CCP model and fusion information (the non-CCP mode and the fusion weight). Then, for a block coded by CCP merge mode, if a CCP merge candidate having fusion information is selected for prediction, the chroma fusion method is used to predict the block. Specifically, the non-CCP mode of the CCP merge candidate is used to generate a first prediction block, the CCP model of the CCP merge candidate is used to generate a second prediction block, and the first and second prediction blocks are blended to generate a third prediction block with the fusion weight of the CCP merge candidate. For intra-CCP merge mode the third prediction block is the final prediction block, while for inter-CCP merge mode the third prediction block is further blended with an inter mode-coded prediction block to generate the final prediction block.

According to another example embodiment of chroma fusion inheritance of the present disclosure, for a chroma block coded by chroma fusion mode with the first chroma fusion method described above with reference to Table 1, the CCP model and the non-CCP mode are stored and used in constructing the CCP merge candidate list for the later-coded chroma blocks coded by any CCP merge mode. When using such a CCP merge candidate to predict a chroma block, the fusion weight is derived in the fashion of the first chroma fusion method in chroma fusion mode. For example, the fusion weight is derived based on the above and left adjacent blocks.

For intra-CCP merge mode, after constructing the CCP merge candidate list, CCP merge candidates in the CCP merge candidate list are reordered by SAD cost, which are obtained using a template of top, left, or top and left adjacent samples of the current block. For inter-CCP merge mode, after constructing the CCP merge candidate list, CCP merge candidates in the CCP merge candidate list having lowest template costs are selected. In some embodiments, if there is a CCP merge candidate having fusion information in the CCP merge candidate list of a chroma block, the fusion information is considered in the reordering of the intra-CCP merge mode and the selecting of the inter-CCP merge mode. Specifically, when the CCP merge candidate having fusion information is used in predicting the template of adjacent samples, the chroma fusion method is used. In some embodiments, if there is a CCP merge candidate having fusion information in the CCP merge candidate list of a chroma block, the fusion information is not considered in the reordering of the intra-CCP merge mode and the selecting of the inter-CCP merge mode. Specifically, when the CCP merge candidate having fusion information is used in predicting the template of adjacent samples, only the CCP model of the CCP merge candidate is used.

In some embodiments, when performing prediction by a CCP merge mode with a CCP merge candidate having fusion information, the fusion information is stored and used in constructing the CCP merge candidate list for later-coded chroma blocks coded by any CCP merge mode. In other embodiments, the fusion information is not stored.

According to an example embodiment of updating a CCP model by a current reconstructed block of the present disclosure, a self-reconstructed CCP model is constructed in addition to an adjacent-reconstructed CCP model as specified by ECM. According to ECM, for a CCP mode-coded chroma block, a CCP model is constructed by adjacent reconstructed samples in the reference area or inherited from a CCP merge candidate and used for predicting the current block. This CCP model is subsequently referred to as an “adjacent-reconstructed CCP model” in this disclosure.

The adjacent-reconstructed CCP model has a type related to the CCP mode. For example, for a CCLM mode-coded block, the type of the CCP model is a CCLM model, which can be represented by Equation 1 above. For example, for a default CCCM mode-coded block, the type of the CCP model is a default CCCM model, which can be represented by Equation 21 above. The adjacent-reconstructed CCP model is stored and used in constructing the CCP merge candidate list for later-coded chroma blocks coded by any CCP merge mode.

According to a first example embodiment of updating a CCP model by a current reconstructed block of the present disclosure, for a CCP mode-coded chroma block, a self-reconstructed CCP model is constructed from the reconstructed chroma samples in the current chroma block and collocated reconstructed luma samples thereof, after the reconstruction of the current chroma block. The self-reconstructed CCP model, rather than the adjacent-reconstructed CCP model, is stored and used in constructing the CCP merge candidate list for later-coded chroma blocks coded by any CCP merge mode. In one example, the type of the self-reconstructed CCP model is the same as the adjacent-reconstructed CCP model. In another example, the type of the self-reconstructed CCP model is single-model default CCCM model. In another example, the type of the self-reconstructed CCP model is multi-model default CCCM model.

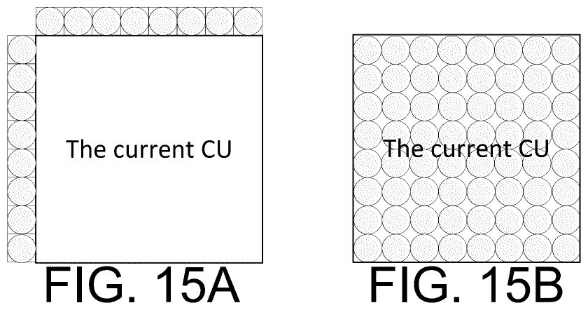

For example, a chroma block is coded by a CCLM_LT mode. The adjacent-reconstructed CCP model used to predict the chroma block is constructed from the adjacent reconstructed samples in the reference area of the current chroma block as illustrated by FIG. 15A. After the reconstruction of the chroma block, a self-reconstructed CCP model is constructed from the reconstructed samples of the current chroma block as illustrated by FIG. 15B.

According to ECM, the offsetLuma and offsetChroma of CCCM modes are related to the reference sample values just outside of the top-left corner of the PU and the multi-model threshold is related to the average of the values of the luma reconstructed adjacent samples after down-sampling in the reference area. Herein, according to an example embodiment, the offsetLuma, offsetChroma, and the multi-model threshold of the self-reconstructed CCP model is the same as the adjacent-reconstructed CCP model. According to another example embodiment, the offsetLuma, offsetChroma, and the threshold of the self-reconstructed CCP model are calculated from reconstructed samples of the current block. For example, offsetLuma and the threshold can be derived from the average value of the reconstructed luma samples after down-sampling in the collocated luma block, and offsetChroma can be derived from the average value of the reconstructed chroma samples in the current chroma block.

In some embodiments, a subset of the reconstructed chroma samples in the current chroma block and the collocated reconstructed luma samples are used to derive the self-reconstructed CCP model.

According to another example embodiment of updating a CCP model by a current reconstructed block of the present disclosure, for a non-CCP mode-coded chroma block, a self-reconstructed CCP model is constructed from the reconstructed chroma samples in the current chroma block and collocated reconstructed luma samples thereof, after the reconstruction of the current chroma block. The self-reconstructed CCP model is stored and used in constructing the CCP merge candidate list for later-coded chroma blocks coded by any CCP merge mode. In one example, the type of the self-reconstructed CCP model is single-model default CCCM model. In another example, the type of the self-reconstructed CCP model is multi-model default CCCM model.

In some embodiments, the CCP model from a non-CCP mode-coded chroma block cannot be a history-based candidate. In some embodiments, the CCP model from a non-CCP mode-coded chroma block can only be an adjacent candidate.

In some embodiments, when reordering the CCP merge candidate list, the candidates from a CCP mode-coded block and the candidates from a non-CCP mode-coded block should have different factors. Template costs of each candidate are multiplied by the corresponding factor before comparing.

According to an example embodiment of adaptive fusion for interCCCM mode and inter-CCP merge mode of the present disclosure, for both interCCCM mode and inter-CCP merge mode, a prediction block generated by a CCP model is blended with a prediction block generated by the inter mode or IBC mode of the current block with a fixed fusion weight {w_{ccp},wᵢₙₜₑᵣ}={3/4, 1/4}. The w_{ccp} is the weight of the prediction block generated by the CCP model and the wᵢₙₜₑᵣ is the weight of the prediction block generated by inter mode or IBC mode.

According to a first example embodiment of adaptive fusion for interCCCM mode and inter-CCP mode of the present disclosure, an extended fusion weight list for interCCCM mode and inter-CCP merge mode is provided. The following fusion weights are supported: {1/16, 15/16}, {2/16, 14/16}, {3/16, 13/16}, {4/16, 12/16}, {5/16, 11/16}, {6/16, 10/16}, {7/16, 9/16}, {8/16, 8/16}, {9/16, 7/16}, {10/16, 6/16}, {11/16, 5/16}, {12/16, 4/16}, {13/16, 3/16}, {14/16, 2/16}, {15/16, 1/16}. In some embodiments, a subset of the fusion weights is supported. In one example, the following fusion weights are supported: {2/16, 14/16}, {4/16, 12/16}, {6/16, 10/16}, {8/16, 8/16}, {10/16, 6/16}, {12/16, 4/16}, {14/16, 2/16}. In another example, the following fusion weights are supported: {4/16, 12/16}, {8/16, 8/16}, {12/16, 4/16}. In another example, the following fusion weights are supported: {4/16, 12/16}, {12/16, 4/16}.

In some embodiments, a syntax element is signaled to indicate which fusion weight is used. In some embodiments, the CCP model and the inter or IBC mode is used to predict the template and blended with the supported fusion weights, the predicted values of the template and the reconstructed value of the template are used to calculate the template cost, and the fusion weight having lowest template cost is selected to predict the current chroma block. In some embodiments, the supported fusion weights are reordered by template cost and the lowest N fusion weights are saved, and a syntax element is signaled to indicate which of the saved fusion weights is selected to predict the current chroma block.

According to another example embodiment of adaptive fusion for interCCCM mode and inter-CCP merge mode of the present disclosure, the CCP model and the inter or IBC mode is used to predict the template, and the predicted values of the template and the reconstructed value of the template are used to calculate a template cost of the CCP mode and a template cost of the inter or IBC mode. Then, the fusion weight is derived based on the two template costs. In one example, the template cost is calculated by SAD. In another example, the template cost is calculated by sum of absolute transformed difference (“SATD”).

In some embodiments, fusion weight derivation can be different for inter-CCP merge mode and interCCCM mode. In one example, an extended fusion weight list is provided for inter-CCP merge mode and is not provided for interCCCM mode. In another example, different extended fusion weight lists are provided for inter-CCP merge mode and interCCCM mode. In another example, an extended fusion weight list is provided for interCCCM merge mode and can be inherited from CCP merge candidate for inter-CCP merge mode. In another example, the fusion weight is signaled for inter-CCP merge mode and derived by template for interCCCM mode.

According to an example embodiment of adaptive model derivation for interCCCM mode of the present disclosure, for interCCCM mode, the prediction blocks of luma and chroma components are used to derive an interCCCM model.

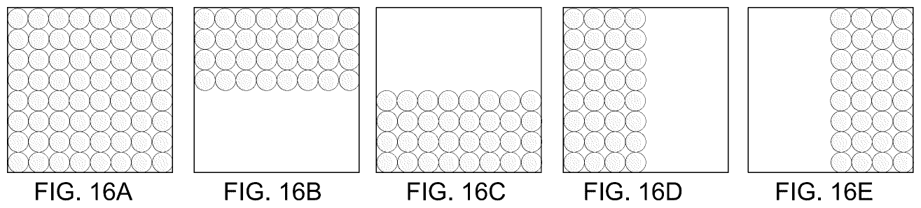

According to a first example embodiment of adaptive model derivation for interCCCM mode of the present disclosure, for interCCCM mode, predicted luma and chroma samples in different parts of the current block are used to derive the interCCCM model. In one example, five parts are supported: the whole block, the upper half block, the bottom half block, the left half block, and the right half block as illustrated by FIGS. 16A through 16E. In one example, a syntax element is signaled to indicate which part is used. In another example, the template cost is used to derive the part.

In some embodiments, only a subset of the samples in the selected part are used to derive the interCCCM model.

FIG. 17 illustrates an example system 1700 for implementing the processes and methods described above for implementing cross-component prediction.

The techniques and mechanisms described herein may be implemented by multiple instances of the system 1700 as well as by any other computing device, system, and/or environment. The system 1700 shown in FIG. 17 is only one example of a system and is not intended to suggest any limitation as to the scope of use or functionality of any computing device utilized to perform the processes and/or procedures described above. Other well-known computing devices, systems, environments and/or configurations that may be suitable for use with the embodiments include, but are not limited to, personal computers, server computers, hand-held or laptop devices, multiprocessor systems, microprocessor-based systems, set top boxes, game consoles, programmable consumer electronics, network PCs, minicomputers, mainframe computers, distributed computing environments that include any of the above systems or devices, implementations using field programmable gate arrays (“FPGAs”) and application specific integrated circuits (“ASICs”), and/or the like.

The system 1700 may include one or more processors 1702 and system memory 1704 communicatively coupled to the processor(s) 1702. The processor(s) 1702 may execute one or more modules and/or processes to cause the processor(s) 1702 to perform a variety of functions. In some embodiments, the processor(s) 1702 may include a central processing unit (“CPU”), a graphics processing unit (“GPU”), both CPU and GPU, or other processing units or components known in the art. Additionally, each of the processor(s) 1702 may possess its own local memory, which also may store program modules, program data, and/or one or more operating systems.

Depending on the exact configuration and type of the system 1700, the system memory 1704 may be volatile, such as RAM, non-volatile, such as ROM, flash memory, miniature hard drive, memory card, and the like, or some combination thereof. The system memory 1704 may include one or more computer-executable modules 1706 that are executable by the processor(s) 1702.

The modules 1706 may include, but are not limited to, one or more of an encoder 1708 and a decoder 1710.

The encoder 1708 may be a VVC-standard encoder implementing any, some, or all aspects of example embodiments of the present disclosure as described above, and executable by the processor(s) 1702 to configure the processor(s) 1702 to perform operations as described above.

The decoder 1710 may be a VVC-standard encoder implementing any, some, or all aspects of example embodiments of the present disclosure as described above, executable by the processor(s) 1702 to configure the processor(s) 1702 to perform operations as described above.

The system 1700 may additionally include an input/output (“I/O”) interface 1740 for receiving image source data and bitstream data, and for outputting reconstructed pictures into a reference picture buffer or DPB and/or a display buffer. The system 1700 may also include a communication module 1750 allowing the system 1700 to communicate with other devices (not shown) over a network (not shown). The network may include the Internet, wired media such as a wired network or direct-wired connections, and wireless media such as acoustic, radio frequency (“RF”), infrared, and other wireless media.

Some or all operations of the methods described above can be performed by execution of computer-readable instructions stored on a computer-readable storage medium 1730, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media may include volatile memory (such as random-access memory (“RAM”)) and/or non-volatile memory (such as read-only memory (“ROM”), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient or non-transitory computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (“PRAM”), static random-access memory (“SRAM”), dynamic random-access memory (“DRAM”), other types of random-access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. A computer-readable storage medium employed herein shall not be interpreted as a transitory signal itself, such as a radio wave or other free-propagating electromagnetic wave, electromagnetic waves propagating through a waveguide or other transmission medium (such as light pulses through a fiber optic cable), or electrical signals propagating through a wire.

The computer-readable instructions stored on one or more non-transient or non-transitory computer-readable storage media that, when executed by one or more processors, may perform operations described above with reference to FIGS. 1A-16E. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
reconstructing a current chroma block;
constructing a self-reconstructed cross-component prediction (“CCP”) model based on reconstructed chroma samples of the current chroma block and collocated reconstructed luma samples thereof; and
constructing a CCP merge candidate list for a later-coded chroma block coded by a CCP merge mode, the CCP merge candidate list comprising the self-reconstructed CCP model.

2. The method of claim 1, wherein the CCP merge candidate list does not comprise an adjacent-reconstructed CCP model;
wherein the adjacent-reconstructed CCP model comprises adjacent reconstructed samples to the current chroma block, or the adjacent-reconstructed CCP model is inherited from a CCP merge candidate.

3. The method of claim 2, wherein the self-reconstructed CCP model and the adjacent-reconstructed CCP model are both single-model or are both multi-model.

4. The method of claim 1, wherein the current chroma block is coded by CCP mode.

5. The method of claim 1, wherein the current chroma block is coded by a non-CCP mode.

6. The method of claim 1, wherein the self-reconstructed CCP model comprises a single-model default Convolutional Cross-Component Model (“CCCM”) model.

7. The method of claim 1, wherein the self-reconstructed CCP model comprises a multi-model default Convolutional Cross-Component Model (“CCCM”) model.

8. A computing system, comprising:
one or more processors, and
a computer-readable storage medium communicatively coupled to the one or more processors, the computer-readable storage medium storing computer-readable instructions executable by the one or more processors that, when executed by the one or more processors, perform associated operations comprising:
reconstructing a current chroma block;
constructing a self-reconstructed cross-component prediction (“CCP”) model based on reconstructed chroma samples of the current chroma block and collocated reconstructed luma samples thereof; and
constructing a CCP merge candidate list for a later-coded chroma block coded by a CCP merge mode, the CCP merge candidate list comprising the self-reconstructed CCP model.

9. The computing system of claim 8, wherein the CCP merge candidate list does not comprise an adjacent-reconstructed CCP model;
wherein the adjacent-reconstructed CCP model comprises adjacent reconstructed samples to the current chroma block, or the adjacent-reconstructed CCP model is inherited from a CCP merge candidate.

10. The computing system of claim 9, wherein the self-reconstructed CCP model and the adjacent-reconstructed CCP model are both single-model or are both multi-model.

11. The computing system of claim 8, wherein the current chroma block is coded by CCP mode.

12. The computing system of claim 8, wherein the current chroma block is coded by a non-CCP mode.

13. The computing system of claim 8, wherein the self-reconstructed CCP model comprises a single-model default Convolutional Cross-Component Model (“CCCM”) model.

14. The computing system of claim 8, wherein the self-reconstructed CCP model comprises a multi-model default Convolutional Cross-Component Model (“CCCM”) model.

15. A computing system, comprising:
one or more processors, and
a computer-readable storage medium communicatively coupled to the one or more processors, the computer-readable storage medium storing computer-readable instructions executable by the one or more processors that, when executed by the one or more processors, perform associated operations comprising:
generating a first prediction block by a CCP model;
generating a second prediction block by an inter mode or an IBC mode; and
blending the first prediction block and the second prediction block based on a fusion weight.

16. The computing system of claim 15, wherein the operations further comprise:
selecting the fusion weight from a fusion weight list based on a signaled syntax element.

17. The computing system of claim 15, wherein the operations further comprise:
predicting a template based on the CCP model and one of the inter mode or the IBC mode; and
calculating a template cost by blending the predicted template with each fusion weight of a fusion weight list.

18. The computing system of claim 17, wherein the operations further comprise:
selecting a fusion weight having a lowest template cost from the fusion weight list.

19. The computing system of claim 17, wherein the operations further comprise:
ordering the fusion weight list by template cost; and
selecting a plurality of lowest-cost fusion weights from the fusion weight list based on a signaled syntax element.

20. The computing system of claim 15, wherein the operations further comprise:
predicting a template based on CCP model and one of the inter mode or the IBC mode;
calculating a first template cost of the CCP model and a second template cost of the one of the inter mode or the IBC mode; and
deriving the fusion weight based on the first template cost and the second template cost.
